(19) United States
(12) Patent Application Publication
(10) Pub. No.: US 2004/0113430 A1
(43) Pub. Date: Jun. 17, 2004

(54) Gravity motor and method

(76) Inventor: William Clinch, Brielle, NJ (US)

Correspondence Address: MESMER & DELEAULT, PLLC, 41 BROOK STREET, MANCHESTER, NH, 03104, US

(21) Appl. No.: 10/729,749

(22) Filed: Dec. 5, 2003

Related U.S. Application Data
(63) Continuation of application No. 10/075,185, filed on Feb. 15, 2002, now abandoned.

(51) Int. Cl. H02P 9/04

(52) U.S. Cl. 290/1 R

(57) ABSTRACT

A gravity motor has an output shaft, a support structure for rotatably supporting the output shaft, a rotor having a hub and a plurality of radial arms secured to the output shaft, a plurality of movable weights where at least one weight is slidably connected to each of the radial arms, a first guide surface positioned to be contactable by each of the movable weights where the first guide surface causes each of the movable weights to move from a distal end of the radial arm toward the hub as the rotor rotates, and a second guide surface positioned to be contactable by each of the movable weights where the second guide surface causes each of the movable weights to move away from the hub to the distal end of the radial arm as the rotor rotates.

This application is a Continuation application of Ser. No. 10/075,185, filed on Feb. 15, 2002.

### BACKGROUND OF THE INVENTION

1. Field of the Invention

The present invention relates generally to motors. Particularly the present invention relates to a motor that utilizes the force of gravity to impart rotational torque on a rotor.

2. Description of the Prior Art

Motors come in a variety of types. The function of any motor is to receive input energy and produce an output usually in the form of rotational torque through an output shaft. The shaft typically operates a load such as a generator to produce electricity, a pump to pump water, to turn a wheel, or to operate any other device requiring rotational torque.

A gravity motor is much like a wind machine, or a waterwheel, or a machine that operates by solar energy. All use natural, readily available energy sources. Generally, some means are provided for producing a weight imbalance either in or about the rotor to provide the rotary motion. Unlike wind or water or solar energy sources, gravity is a force with a constant value on earth. Harnessing this gravitational force as the input energy source for a motor would provide a motor that is not dependent on uncontrollable factors that determine the availability of the supply of the input source, which exists with wind, water or solar energy. Many attempts have been made to design a motor that utilizes the force of gravity as the input energy source.

U.S. Pat. No. 6,237,342 (2001, Hurford) discloses a gravity motor which is formed of at least one motor unit which has at least one motor member fixed to an output shaft. The output shaft is rotationally mounted on a housing. The housing includes a guide surface. The motor member is longitudinally movable relative to an output shaft. Each end of the motor member includes a weighted follower that is movable relative to a guide surface. The rotation of the motor unit caused one weighted follower to be moved toward the output shaft by the guide surface with the opposite weighted follower of the motor member being moved away from the output shaft. A problem with the Hurford device is the requirement to slide the entire follower shaft and the followers across the rotational axis of the motor, which increases resistance. Another problem is the multiplicity of parts involved.

U.S. Pat. No. 4,121,420 (1978, Schur) discloses a gravity actuated thermal motor. The motor includes a rotor in the form of a ring-shaped annulus that is filled with water. A plurality of collapsible bellows is connected to and extends inwardly from the outer peripheral wall of the annulus into the water-filled chamber. In communication with each of the bellows and extending outwardly from the outer peripheral wall of the annulus is a plurality of refrigerant-containing tanks, one tank being in communication with the interior portion of one bellows. A source of heat in the form of a hot water trough is positioned at the lower portion of the rotor so as to be intercepted by the refrigerant containers upon rotation of the annulus. The vapor produced by the volatile refrigerant expands the bellows and a locking device secures the bellows fully extended on the ascending side of the annulus. An automatic lock release is positioned near the top of the path of travel to release the bellows to enable it to contract during the time that the bellows at the bottom position is expanding. A disadvantage of the Schur device is that it requires water to act as the unbalanced weight, a refrigerant for expansion of the bellows, and hot water to cause the refrigerant to volatilize, not to mention the use of energy to heat the water. The Schur device also suffers from the use of a multiplicity of components, thus, increasing the possibility of mechanical failure.

U.S. Pat. No. 4,311,918 (1982, Vaseen) discloses a wind-powered generator with gravity assisted mechanical advantage booster. It uses the mechanical advantage of a lever arm to multiply the energy of a moving or mobile weight from a propeller drive, which is wind powered. The unit consists of a counter balanced wheel on one side of a centerline shaft and a concentrated weight on the opposite side. Both are kept rigid by a connecting structure beam. The entire unit is made to revolve around the centerline shaft by moving a mobile weight around the wheel perimeter in concert with the unit's rotation. The major disadvantage of the Vaseen device is its reliance on wind energy to function.

U.S. Pat. No. 5,221,868 (1993, Arman) discloses an electrically assisted gravity powered motor. The device has a plurality of hexagonal arms with two opposing shorter sides describing a circle as the arms are rotated by an interrupted axle running between the arms. There is sufficient room inside the hexagon for weights on tracks between the two opposing sides to be moved by a fixed motor at one end of each track. The weight moves along the track through an axis in an unrestricted manner from one end to the other end and back while the arm is electrically rotated continuously in a 360° circle. The Arman device also suffers the disadvantage of requiring a second source of energy, electrical energy to drive the fixed motor at the end of each track.

U.S. Pat. No. 3,735,839 (1973, Moisdon) discloses a gravity motor having a vacuum body that has a plurality of units. Each unit includes an unbalanced weight and mechanical gear box where either direction of rotation of a reversible shaft is used to tighten a mechanical spring coupled to the shaft of the motor for subsequent release to rotate the shaft as an output shaft. The disadvantage of the Moisdon device is the multiplicity of mechanical parts and the complexity of the device.

Each of the devices described above has disadvantages in one or more respects, which has hindered their widespread adoption and use.

Therefore, what is needed is a gravity motor that is simple, does not require the use of a second source of energy, and is easy to manufacture

### SUMMARY OF THE INVENTION

It is an object of the present invention to provide a gravity motor that does not require a second source of energy for the successful operation of the motor. It is another object of the present invention to provide a gravity motor that is simple to manufacture and assemble.

The present invention achieves these and other objectives by providing a gravity motor that has at least one hub mounted to a rotatable output shaft, a plurality of radial arms connected to the hub, a plurality of movable weights where each weight is slidably attached to one of the plurality of arms, a first guide surface positioned to guide the weights from the distal end of the radial arm to the proximal end of the radial arm near the hub, a second guide surface positioned to guide the weights from the proximal end near the hub to the distal end of the radial arm, and a support structure for supporting the rotatable output shaft and the first and second guide surfaces. The first and second guide surfaces are asymmetrical relative to the axis of rotation of the output shaft. Typically, the weights located at the distal end of the radial arm make initial contact with the first guide surface through each revolution of the radial arm when the gravitational potential energy of the weight is at approximately its lowest value through the rotation.

The present invention works in the following way. As a first movable weight comes into contact with the first guide surface, the first movable weight is moved along its radial arm to a position closer to the output shaft. This typically occurs when the radial arm has moved through a 90° rotational angle. While this is occurring, a second movable weight slidably connected to an opposite radial arm comes into contact with the second guide surface. The second movable weight is moved along its radial arm toward the distal end of the radial arm. The movable weight at the distal end of the radial arm is positioned at the end of the second guide surface so that the movable weight is subjected to the unrestricted, downward pull of gravity. Since the second movable weight is located further from the output shaft than the movable weight that is being moved from the six o'clock position to the twelve o'clock position, there is a net downward rotational torque that causes the output shaft to rotate clockwise.

The present invention modifies energy from a natural source by using and including other physical aspects including momentum and centrifugal forces in conjunction with leverage, weight and cyclic shift to cause a continuous unsymmetrical rotary motion. The rotary motion acts upon a shaft to transfer energy for useful and beneficial purposes.

### BRIEF DESCRIPTION OF THE DRAWINGS

FIG. 1 is a perspective view of the present invention showing the drive unit, the movable weights, the first and second guide surfaces, and the rotatable shaft supported by shaft supports.

FIG. 2 is a perspective view of the present invention shown in FIG. 1 with the front shaft support and the side walls removed for clarity.

FIG. 3 is a front plan view of the present invention showing the rotor, the movable weights and the guide surfaces.

FIG. 4 is a perspective view of the hub of the rotor of the present invention.

FIG. 5A is an expanded, perspective view of a movable weight of the present invention.

FIG. 5B is a plan view of the major components of the movable weight.

FIG. 6 is an isometric view of the present invention showing two drive units combined to form one gravity motor.

FIG. 7 is a side view of the radial arms of the gravity motor shown in FIG. 6 showing their mirror-image assembly.

FIG. 8 is a front plan view of the embodiment shown in FIG. 6.

FIG. 9 is a front plan view of another embodiment of the present invention showing the gap between the guiding surfaces and the weights when magnets or magnetic material is used.

### DETAILED DESCRIPTION OF THE PREFERRED EMBODIMENT

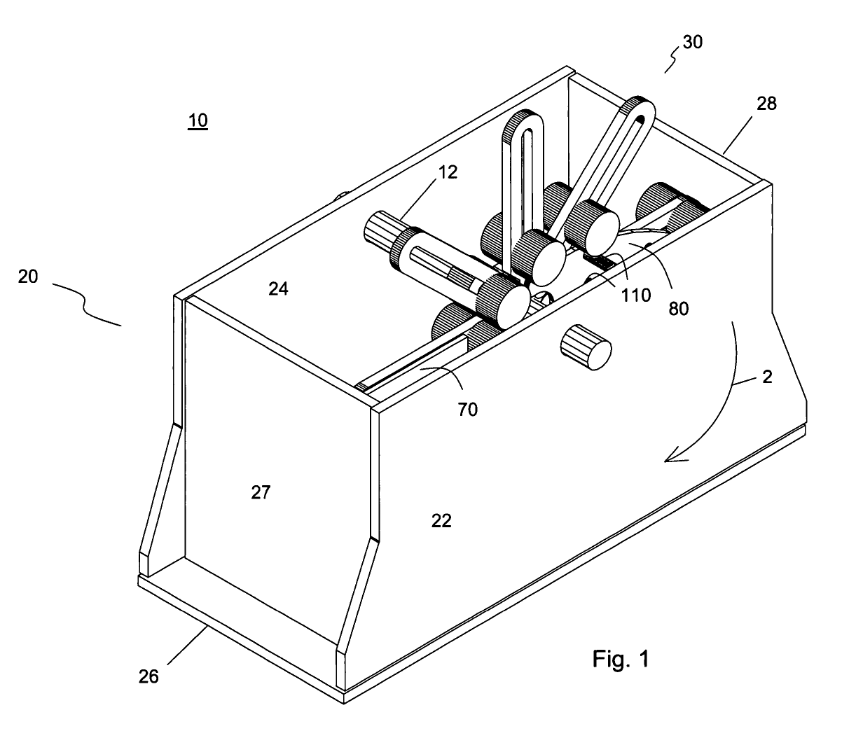

The preferred embodiment(s) of the present invention are illustrated in FIGS. 1-9. Referring to FIG. 1, gravity motor 10 includes a rotatable shaft 12 supported by a support structure 20, and a drive unit 30 fixedly attached to shaft 12, a first guide surface 70 and a second guide surface 80. Support structure 20 includes a first support wall 22, a second support wall 24 and a bottom 26. First and second guide surfaces 70 and 80 are secured to first support wall 22 with cam spacers 110. Support structure 20 also includes side walls 27 and 28. Support walls 22 and 24 typically have bearing assemblies (not shown) for supporting the rotatable shaft 12. It should be noted that drive unit 30 is rotatable clockwise, in this view, as noted by the direction of the arrow 2. It should be understood that clockwise or counterclockwise rotation is relative to the point of view. Drive unit 30 would appear to rotate counterclockwise when viewed from support wall 24.

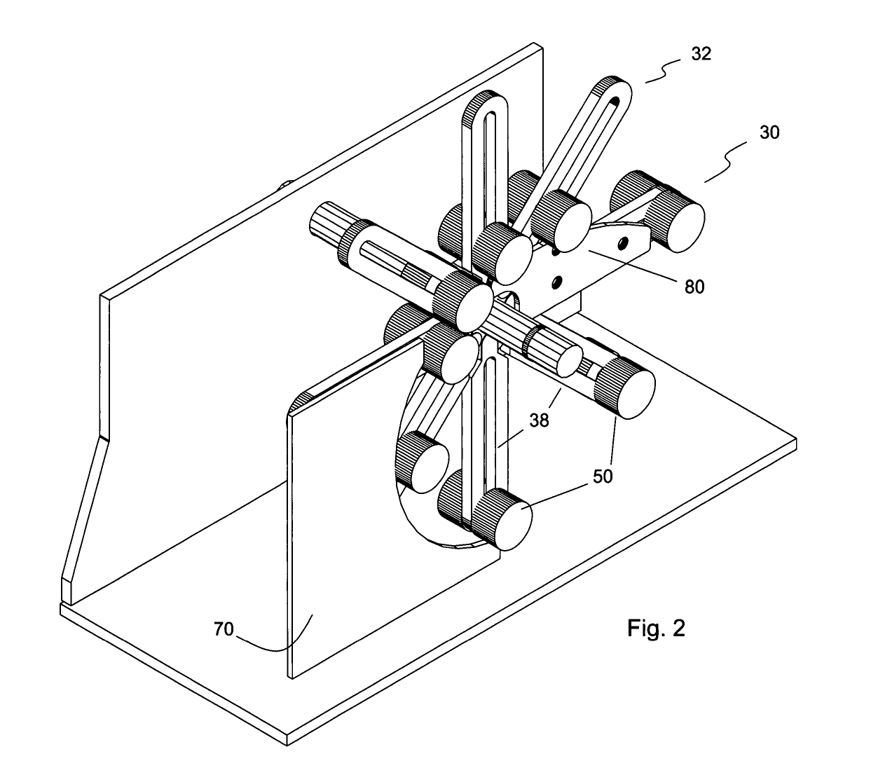

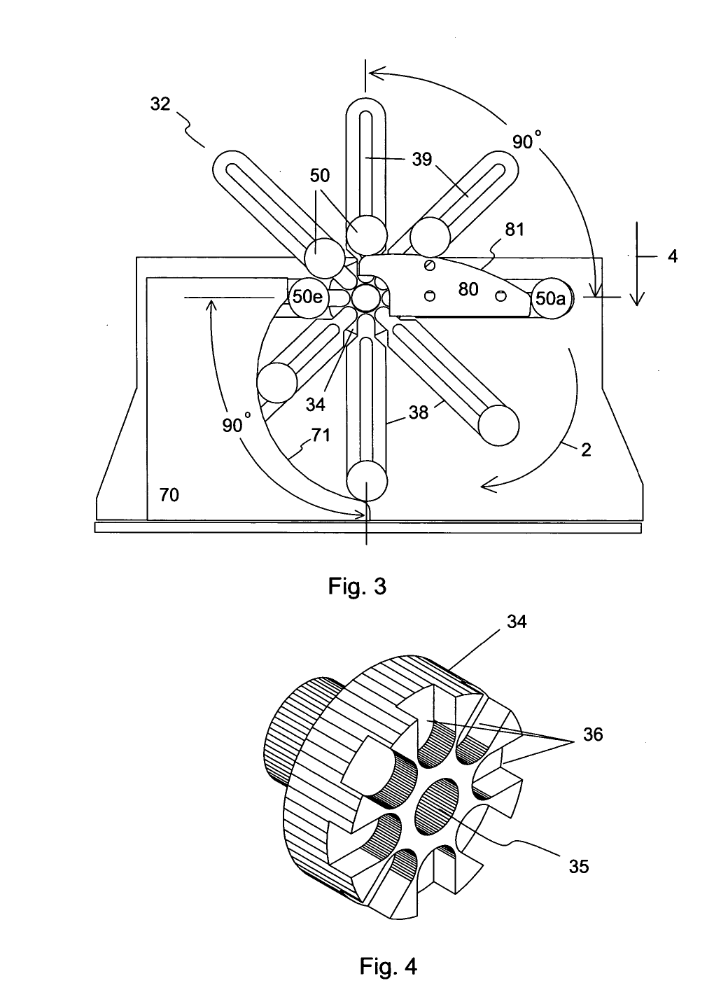

Turning now to FIG. 2, first support wall 22 and side walls 27 and 28 are removed to provide an unobstructed view of drive unit 30 and the first and second guide surfaces 70 and 80. Drive unit 30 includes a rotor 32 fixedly attached to shaft 12 and a plurality of movable weights 50. Movable weights 50 have low friction between the weights 50 and the radial arms 38. As shown in FIG. 3, rotor 32 includes a hub 34 and a plurality of radial arms 38. Each of the radial arms 38 is identical in length, width and shape. Radial arms 38 have elongated openings 39 along which weights 50 move from one end of the elongated opening 39 to the other end. First guide surface 70 is positioned to be contactable by each of the movable weights 50. First guide surface 70 includes a concave surface 71 having a radius such that concave surface 71 causes each of the movable weights 50 to move in an unsymmetrical configuration, in turn, from the distal ends of radial arms 38 toward hub 34 as drive unit 30 rotates through about a ninety degree (90°) angle of rotation. Second guide surface 80 is also positioned to be contactable by each of the movable weights 50. Second guide surface 80 includes a convex surface 81 having a radius whereby the convex surface 81 causes each of the movable weights 50 to move, in turn, from near the hub 34 to the distal ends of radial arms 38 as drive unit 30 rotates through about a one hundred ten degree (110°) angle of rotation.

FIG. 4 shows an enlarged view of hub 34. Hub 34 includes a central, through hole 35 for receiving shaft 12, and a plurality of equally-spaced, radial recesses 36 for receiving the proximal ends of radial arms 38. Although hub 34 has eight recesses for receiving eight radial arms, it should be understood that the quantity of radial arms used on each hub is dependent upon the size of the weights used. The larger the weights the fewer number of radial arms that can be used due to the space required by the weights as they move from the distal ends of the radial arms 38 to the hub 34. If larger weights are used, a second set of first and second guide surfaces 70 and 80 may be incorporated on the opposite sides of the radial arms. Such an arrangement would cause a more even distribution of the force imposed on the weights by the guide surfaces. The force would be distributed onto a portion of the weight on each side of the radial arm in order to move the weights along the radial arms. This arrangement may enhance useful life of the weights, hub and radial arms. Radial arms 38 are secured to hub 34 using any fastening means known to those skilled in the art. For example, radial arms 38 may be bolted in place, welded, etc. Hub 34 is fixed to shaft 12 preferably using a shaft key and a locking screw/bolt.

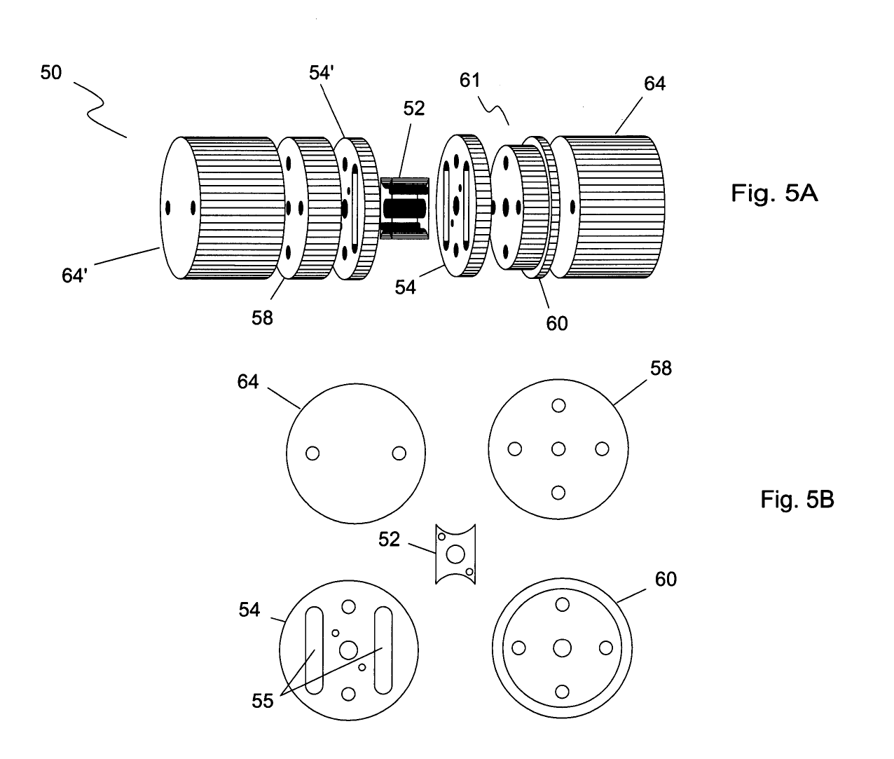

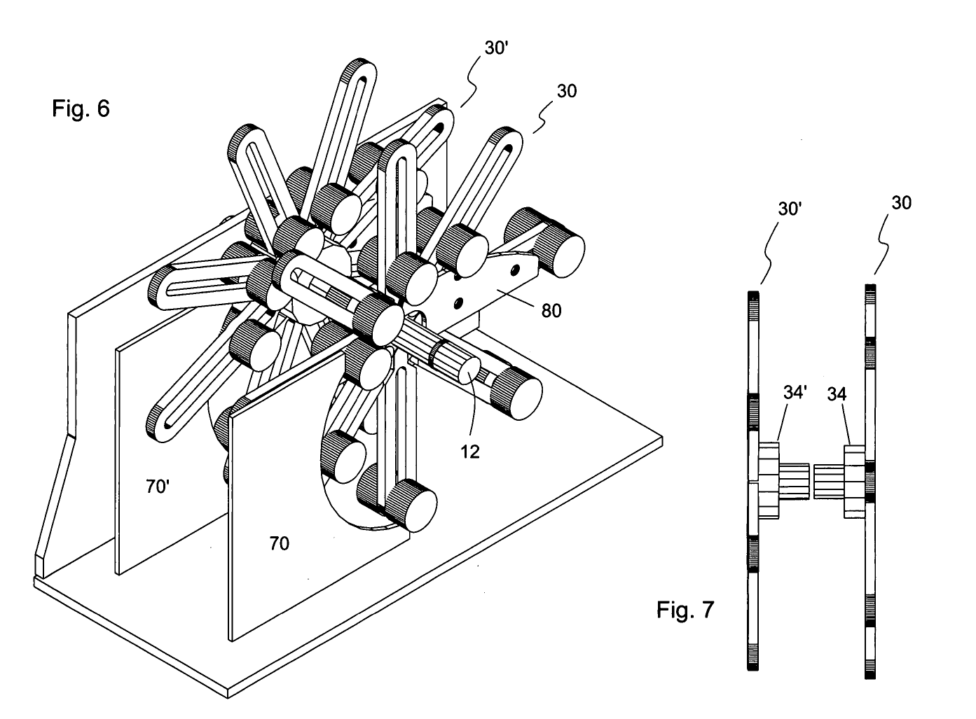

Turning now to FIG. 5A, an example of a movable weight 50 is shown. Movable weight 50 includes a radial arm guide 52, a pair of bearing plates 54 and 54′, a first race plate 58, a second race plate 60, and a pair of weights 64 and 64′. Second race plate 60 includes an undercut region 61 about its circumference for receiving a needle roller shell bearing which rides against concave surface 71 and convex surface 81 as gravity motor 10 rotates.

As is more clearly shown in FIG. 5B, bearing plates 54 and 54′ include a pair of parallel slots 55 for ball bearings (not shown). Radial arm guide 52 has a width that is slightly narrow than the width of elongated openings 39 of radial arms 38, and a thickness that is slightly larger than the thickness of radial arms 38. The radial arm guide 52 bridges and connects, by way of bolts and/or machine screws, bearing plate 54, race plate 60 and weight 64 on one side of radial arm 38 to bearing plate 54′, race plate 58 and weight 64′ on the other side of radial arm 38 through the elongated opening 39. Radial arm guide 52 is designed to permit the weights 50 to move between the distal and proximal ends of radial arms 38. This is achieved by the use of ball bearings within slots 55 rolling between the surfaces adjacent the elongated openings 39 of the radial arms 38 and the surfaces of the first and second race plates 58 and 60. Bearings are also used between radial arm guide 52 and the radial arm 38 to promote low friction as the weights 50 move back and forth along radial 38. A variety of materials may be used to make the various components of the present invention. Examples of acceptable materials are steel, tungsten, aluminum, carbon fiber, and materials that exhibit similar strength and durability characteristics. The components may be coated and/or heat-treated with other materials to enhance durability and low friction characteristics. It is noted that the weights may use other types of bearings and radial arms where the weights ride on the outside of the radial arms such that a central, elongated slot in the radial arm is not needed. In fact, it is the use of movable weights that are guided to move back and forth along a fixed radial arm as that radial arm rotates about an axis of rotation that is unique to the present invention.

With reference to FIG. 3, the operation of the gravity motor 10 of the present invention is as follows. An initial torque is applied to gravity motor 10 in the direction of arrow 2, which starts drive unit 30 to rotate clockwise. When movable weights 50, in turn, contact the portion of first guide surface 70 that is located at the six o'clock position, and as the drive unit 30 continues to rotate, the position and radius of concave surface 71 is such that weights 50 will be moved toward hub 34 until weights 50 are located, in turn, nearest hub 34. While this is occurring, weights 50 that have completed their rotation of approximately 90° along concave surface 71 are now, in turn, positioned to contact a portion of second guide surface 80 that is located at the twelve o'clock position. The position of convex surface 81 is such that weights 50 will be moved away from hub 34 until weights 50 are located, in turn, at the distal ends of their respective radial arms 38.

The result is the force of gravity, which is constant and in the direction of arrow 4, exerts a clockwise torque on rotor 32. Movable weights 50 are to be weighted to maximize this torque. Because movable weight 50a is located further from the hub 34 than movable weight 50e, there is a net overall torque in the direction of arrow 2. This overall torque produces the rotation of the shaft 12. As long as this overall torque is greater than the losses that are inherently created in the operation of the gravity motor 10 of the present invention, then the drive unit 30 will continue to rotate clockwise.

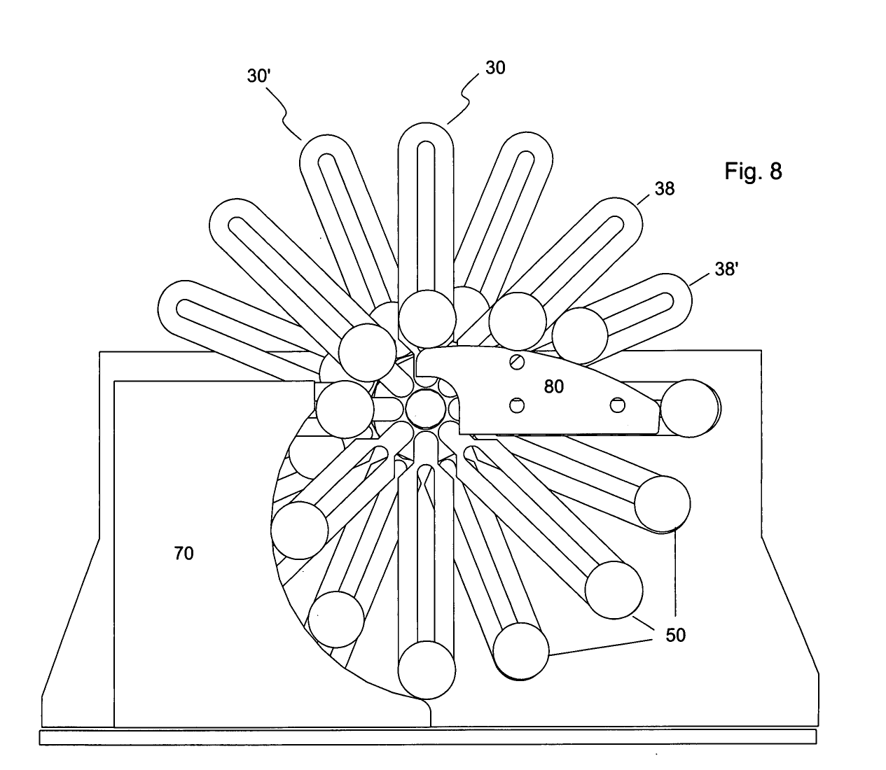

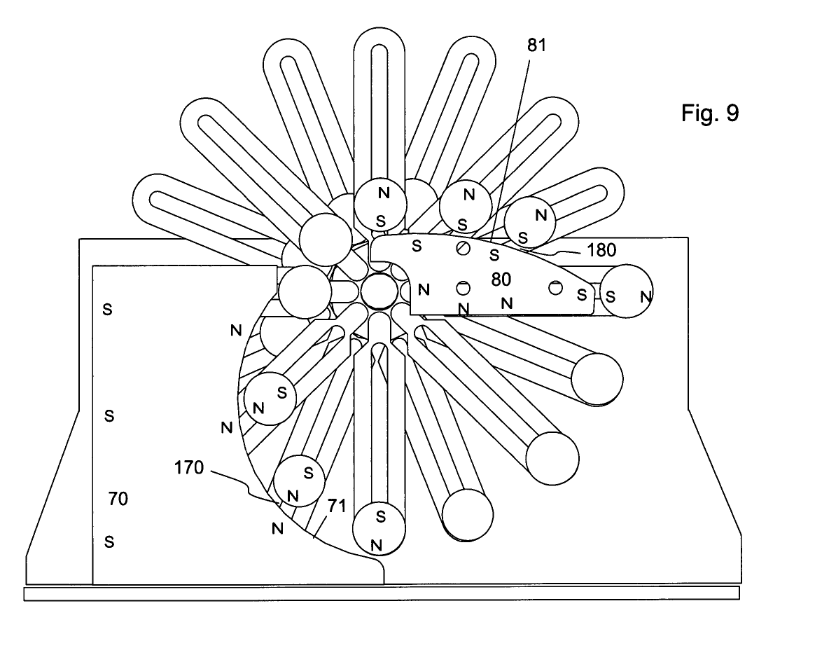

Referring to FIGS. 6, 7 and 8, there is shown another embodiment of the present invention. Within this embodiment, like numerals have been utilized relative to the first embodiment 10 of this invention to refer to like parts. However, instead of having a single drive unit 30, there is also included a second drive unit 30′ located in a mirror-image relationship, as shown in FIG. 7, connected to rotatable shaft 12. Shaft 12 is mounted, as before, within the support structure 20. Drive units 30 and 30′ are essentially identical and similar in construction. The position of each of the drive units 30 and 30′ could be such that the radial arms 38 and 38′ are in transverse alignment or in an offset alignment as shown in FIG. 8. The offset alignment is preferred for achieving a smooth running output torque within shaft 12. It should be understood that any number of drive units 30 may be ganged together using appropriate supporting structures on a single shaft 12 to provide additional torque to the shaft 12.

Low-friction coatings may also be used on the contacting surfaces of the movable weights 50, radial arms 38, instead of bearings, and concave and convex surfaces 71 and 81, respectively. Examples of low friction coatings are slippery plastic materials such as is commonly sold under the trademark “Teflon,” or other plastic materials impregnated with oil for low friction characteristics. Magnets and magnetic material coatings may also be used. In this embodiment, the guiding surfaces 70 and 80 are made of a magnet, or other material coated with a magnetic coating, having a north pole and a south pole. The weights 50 are also magnets, or other material coated with a magnetic coating, having a north pole and a south pole with their north pole positioned to interface with the north pole surface of the first guiding surface and their south pole positioned to interface with the south pole surface of the second guiding surface.

The movable weights 50 are connected to radial arms 38 in an equivalent manner similar to the previously described ball-bearing based embodiment. The movable weights 50 become located directly adjacent the guide surfaces 70 and 80 but do not contact the surfaces. Because there are repelling poles between the movable weights 50 and the guide surfaces 70 and 80, there will be an automatic repelling force created. As shown in FIG. 9, this repelling force will cause the weight 50 to move away from guide surface 70 and be located a short gap 170 from concave surface 71. Likewise, the repelling force will cause weight 50 to move away from guide surface 80 and be located a short gap 180 from convex surface 81.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A gravity motor comprising:
a support structure;
an output shaft rotatably mounted to said support structure;
a rotor having a hub and a plurality of radial arms secured to said output shaft;
a plurality of movable weights wherein at least one of each of said movable weights is slidably connected on one of each of said plurality of radial arms;
a first guide surface mounted on said support structure wherein said first guide surface is positioned to be contactable by each of said movable weights, said first guide surface causing each of said movable weights to move from a distal end of said plurality of radial arms toward said hub as said rotor rotates; and
a second guide surface mounted on said support structure wherein said second guide surface is positioned to be contactable by each of said movable weights, said second guide surface causing each of said movable weights to move from said hub to said distal end of said radial arms as said rotor rotates;
wherein said rotor with said plurality of weights, said first guide surface and said second guide surface are collectively a drive unit whereby said movable weights located at said distal end of said radial arms results in an overall torque caused by gravity causing rotation of said output shaft.

2. The gravity motor of claim 1 further comprising two or more of said drive units.

3. The gravity motor of claim 1 wherein said movable weights further include bearings.

4. The gravity motor of claim 1 wherein said rotor is a unitary component.

5. The gravity motor of claim 1 wherein said radial arms are removably attached to said hub.

6. The gravity motor of claim 1 wherein said hub is removably attached to said output shaft.

7. The gravity motor of claim 1 wherein said support structure is a housing.

8. The gravity motor of claim 1 wherein said first guide surface causes said movable weights of each of said radial arms to slide from the distal end of each of said radial arms to said hub during about a 90° angle of rotation.

9. The gravity motor of claim 1 wherein said second guide surface causes said movable weights of each of said radial arms to slide from the hub to the end of said radial arm during an angle of rotation of about 110°.

10. The motor of claim 1 wherein each of said plurality of weights begins contact with said first guide surface when the gravitational potential energy of said weight is at its minimum.

11. A gravity motor comprising:
a support means;
a rotatable shaft means mounted to said support means;
hub means fixedly attached to said shaft means, said hub means having a plurality of radial weight holding means;
movable weight means, slidably connected to each of said weight holding means;
a first means for moving each of said movable weight means from a distal end of said weight holding means to said hub means; and
a second means for moving each of said movable weight means from said hub means to said distal end of said weight holding means;
whereby said movable weight means located at said distal end of said weight holding means results in an overall torque caused by gravity causing rotation of said output shaft means.

12. The gravity motor of claim 11 wherein said movable weight means further include bearing means.

13. The gravity motor of claim 11 wherein said hub means and said weight holding means are a unitary component.

14. The gravity motor of claim 11 wherein said weight holding means are removably attached to said hub means.

15. The gravity motor of claim 11 wherein said hub means is removably attached to said output shaft means.

16. The gravity motor of claim 11 wherein said support means is a housing.

17. A method of making a gravity motor, said method comprising:
supporting a rotatable output shaft to a support structure;
fixedly attaching a rotor comprising a hub and a plurality of radial arms to said output shaft;
connecting a slidable movable weight to each of said radial arms;
positioning a first guide surface to one side of said output shaft wherein said first guide surface is contactable by each of said movable weights causing said movable weights to move from the distal end of said radial arms toward the hub; and
positioning a second guide surface on an opposite side of said output shaft wherein said second guide surface is contactable by each of said movable weights causing said movable weights to move from the hub to the distal end of said radial arms;
whereby said movable weights at the distal end of said radial arms impart the rotational torque caused by the pull of gravity on said movable weights.

18. The method of claim 17 further comprising beginning contacting each of said movable weights with said first guide surface when the gravitational potential energy of said movable weight is at about its minimum.

19. The method of claim 17 further comprising contacting said movable weights with said second guide surface when said movable weight is at a rotational position approximately opposite its rotational position when the gravitational potential energy of said movable weight is at about its minimum.

20. A method of producing rotational torque using the pull of gravity, said method comprising:
attaching a rotor to a rotatable shaft, said rotor having a hub with a plurality of radial arms wherein each radial arm has a slidable weight thereon;
moving each of said slidable weights, in turn, from the distal end of said radial arms toward said hub through an angle of rotation of about 90° beginning when said weight reaches a rotational position where the gravitational potential energy of said weight is at about its minimum; and
moving each of said slidable weights, in turn, away from said hub to the distal end of said radial arms through an angle of rotation of about 45° to about 110° beginning when said slidable weight is at a rotational position about opposite its rotational position when the gravitational potential energy of said weight is at about its minimum.
